(19) United States
(12) Patent Application Publication
(10) Pub. No.: US 2025/0382206 A1
(43) Pub. Date: Dec. 18, 2025

(54) NONAQUEOUS SUSPENSIONS, METHODS AND SYSTEMS FOR TREATMENT OF WASTEWATER

(71) Applicant: PSMG, LLC, Ball Ground, GA (US)

(72) Inventor: Jason K. Holt, Ball Ground, GA (US)

(21) Appl. No.: 18/744,205

(22) Filed: Jun. 14, 2024

(51) Int. Cl. C02F 1/52; C02F 1/56; C02F 103/10

(52) U.S. Cl. CPC C02F 1/5272; C02F 1/56; C02F 2103/10; C02F 2303/185

(57) ABSTRACT

A suspension comprising a water soluble polymer suspended as particulates in a nonaqueous liquid is useful for treating water from which contaminant particles need to be removed. The suspension includes mineral oil and at least about 10 wt% of particulate polydiallyldimethylammonium chloride (polyDADMAC) in the form of powder or beads. The suspension can be highly concentrated, for example, up to 80 wt% polyDADMAC. A method and system for delivering the suspension to flowing wastewater is also described. The method and system can be configured to treat water such as wastewater, wherein the wastewater is generated as a waste stream during various large-scale operations such as mining operations.

### FIELD OF THE INVENTION

The invention relates to suspensions of polymer in a non-dissolving liquid such as mineral oil. The suspensions are generally suitable as coagulants for treating waste streams particularly those generated during mining operations. The invention also relates to methods and systems suitable for treating waste streams in which removal of contaminants from waste streams is desired.

### BACKGROUND OF THE INVENTION

Mining waste such as wastewater can have negative impacts on water and soil quality, human health, and ecosystems. Many technologies for treating mining wastewater from mining operations have been developed over the years and include filtration, ion exchange, desalination and biological processes. The particular technology used to treat mining wastewater generally depends on the materials being mined and the particular methods being employed. Hardrock mining includes extraction of primary raw materials, such as non-fuel minerals and mineral deposits of solid ores or eroded deposits. Primary raw materials such as gold and silver play a significant role in the U.S. and global economies with estimated values close to a trillion dollars. Unfortunately, hardrock mining is very destructive to the environment, potentially disturbing large amounts of material and land area and generating large volumes of waste with high waste-to-product ratios.

### SUMMARY OF THE INVENTION

A suspension comprising a water soluble polymer suspended as particulates in a nonaqueous liquid is useful for treating water from which contaminant particles need to be removed. The suspension can comprise mineral oil and at least about 10 wt% of particulate polydiallyldimethylammonium chloride (polyDADMAC) in the form of powder or beads. The suspension can be highly concentrated, for example, up to 85 wt% polyDADMAC. A method and system for delivering the suspension to flowing wastewater is also described. The method and system can be configured to treat water such as wastewater, wherein the wastewater is generated as a waste stream during various large-scale operations such as mining operations.

In a further aspect, the invention relates to a system for treatment of a waste stream, the system comprising a reservoir holding a suspension of particulate cationic polymer in mineral oil, and a conduit connected to the reservoir and configured to deliver the suspension from the reservoir into a waste stream.

### BRIEF DESCRIPTION OF THE DRAWINGS

FIG. 1 is a top schematic view of a layout of an exemplary waste treatment facility involving the delivery of one or more suspensions of the present invention into a waste stream that flows from mineral processing stations into a thickening tank.

FIG. 2 is fragmentary schematic view of an exemplary delivery system configured to direct a suspension of the present invention into a waste stream.

FIG. 3 is a fragmentary schematic view of an exemplary system configured for treating wastewater from a waste stream with the suspension described herein.

### DETAILED DESCRIPTION

A convenient format has been developed for the delivery of particulate flocculant polymers, such as a cationic polymer, as a suspension in a nonaqueous carrier fluid, in particular a mineral oil. The suspension may be highly concentrated for efficient delivery of the particulate cationic polymer, such as polyDADMAC. Due to the nature of the carrier fluid, the cationic polymer does not dissolve. The particulate cationic polymer is generally in the form of a solid such as a powder or beads with limited solubility, or no solubility, in the carrier fluid. Flocculating polymers, including coagulating polymers, include cationic polymers such as polydiallyldimethylammonium chloride (polyDADMAC) or copolymers of diallyldimethyl-ammonium chloride (DADMAC) and are generally high molecular weight water soluble polymers that can be effectively used for treatment of water, fiber dewatering and the like. The particulate cationic polymer generally comprises a water soluble cationic polymer in the form of a powder or bead and can be suspended in the nonaqueous carrier fluid at relatively high concentrations without gelling, which can increase the viscosity to undesirable levels.

Handling and shipping of fine powders and other solids can be problematic for many reasons including, among others, potential air quality and safety issues. These handling and safety issues can be particularly problematic at points of delivery where chemicals are delivered from suitable storage containers, generally without access to sophisticated handling equipment and highly skilled technicians. The suspensions described herein can provide fine powders or other solids at one or more delivery points of a treatment operation, but with significantly simplified and reduced handling and safety issues. In some embodiments, the suspensions are delivered to a site near a delivery point and used “as is”. In other embodiments, the suspensions are delivered to a site and modified prior to being used. For treatment of a waste stream, the suspensions can be metered into the stream at one or more points of delivery along the stream. The treated stream can then proceed to a settling tank, settling pond or the like where flocs formed from the particulate cationic polymer and contaminants settle and can be separated from the stream. Similarly, the suspensions can be used to deliver particulate cationic polymer for fiber dewatering, such as for wastewater treatment or paper formation.

Polymers used to treat water such as waste streams are known. U.S. patent 10,494,523 B2 to Holt, entitled “Particle Suspensions of Flocculating Polymer Powders and Powder Flocculant Polymer Blends,” incorporated herein by reference, describes use of suspended blends of polyethylene oxides, polyDADMAC, polyacrylamides and DADMAC acrylamide copolymers. U.S. Patent 5,698,109 to Payne et al., entitled "Purification of Aqueous Liquor," incorporated herein by reference, describes addition of particulate polymers directly into waste streams. U.S. Patent 5,112,500 to Jones, entitled "Purification of Aqueous Liquor," incorporated herein by reference, describes addition of polyDADMAC solution. The present application is directed to effective and efficient ability to deliver coagulants for a range of application areas.

Polydiallyldimethylammonium chloride (polyDADMAC) is a water-soluble polymer widely utilized as a coagulant in water treatment operations. Traditionally, it is available as a viscous liquid solution with concentrations ranging from 10% to 40% active polyDADMAC dissolved in water. However, the most commonly used version is the 20% solution, as higher concentrations pose challenges in handling and pumping, especially in colder climates. Typically supplied in 275-gallon totes or in bulk, the associated freight costs for transporting a product comprising 80% water are considerable, particularly over long distances to regions like the western United States. Another prevalent form in the mining industry is dry polyDADMAC, which is derived from the liquid version and supplied as drum-dried flakes/powder or unique micro-beads. These dry forms significantly reduce shipping costs and have demonstrated an 8 to 1 performance advantage over their liquid counterparts when applied directly to water treatment streams so that smaller amounts of polymer can be effectively used.

Dry polyDADMAC applications often require the product to be applied from an elevated platform, using dry feed hoppers to dispense it into the wastewater flow. This method, while effective in coal mining operations, is impractical for other mining operations that lack elevated feeder systems. Moreover, pre-mixing and hydrating dry polyDADMAC onsite negates its performance benefits, making it economically unviable. Additionally, the complexity of dry feeder systems contrasts with the simplicity of liquid versions that can be efficiently pumped from ground-level storage tanks.

To address the disadvantages of dry polyDADMAC addition, a low-viscosity liquid suspension of dry DADMAC has been developed. The suspension carrier fluid is designed to be substantially free of water or other solvents that could prematurely hydrate the polyDADMAC. This approach ensures compatibility of the dry DADMAC and stable suspension to prevent settling.

The suspension product can be efficiently pumped from totes or bulk storage to elevated application points, where it can be directly applied to a wastewater stream. This method allows the dry DADMAC particles to disperse within the stream and begin dissolving, thereby maintaining the performance advantages of a dry form over an aqueous solution form. Additionally, the suspension product simplifies operations by eliminating the need for dry feeder systems and reducing the frequency of bag changes or powder loading, while reducing occupational health and safety risks.

The suspensions can be useful for the treatment of various water flows such as those involved in coal mining, mineral mining operation, fiber dewatering, paper processing or paper sheet formation operations. Such processing with the suspensions can be useful to provide or facilitate water clarification, suspended solids separation, treatment flow thickening, dissolved air floatation, selective mineral separation, dredging, belt press or centrifuge dewatering, settling pond or reservoir impoundment, paper sheet formation, stickies control, paper drainage aid, and/or fiber dewatering. While the particulate cationic polymers are generally water soluble, they tend to agglomerate and form colloids at appropriate concentrations in water, which may be driven at least in part by the presence of particulate or fibrous contaminants in the wastewater. Due to colloid formation and agglomeration, the particulate cationic polymers with trapped contaminants can settle from the flow as flocs. As described further below, settling tanks can be used to separate the flocs so that purified water can be separately removed for further processing. If formed at high concentrations in aqueous solutions, colloid formation and agglomeration can result in gelling and a large increase in viscosity that can make it difficult or impractical to pump the resulting polymers into a waste stream. The use of a carrier fluid in which the polymer particulates are not soluble avoids these problems and allows for the delivery and metering of a high concentration polymer suspension using equipment that is generally readily available.

Colloid science describes coagulation and flocculation as different processes used to isolate small particles suspended throughout another substance such as a liquid. For treatment of water, coagulation and flocculation are often used in conjunction in order to remove particles which are contaminants in the water. Coagulating agents or coagulants are added to wastewater to bring the suspended fine matter together by manipulating charges on the matter to form agglomerates or flocs or by reacting with the fine suspended matter to form precipitates. Flocculating agents or flocculants can then be added to bind and agglomerate other matter to form flocs. Coagulating and flocculating agents can be selected such that the flocs float to the top of the water being treated or settle to the bottom. Thus, the flocs may be readily removed from the water being treated by filtration or settling.

For treatment of waste streams generated in mining operations, coagulation and flocculation are often used in conjunction. A waste stream can be treated with one or more coagulants, such as a cationic water soluble polymer, to neutralize repulsive charges and cause formation of agglomerates or small flocs, referred to as pin flocs. One or more flocculants, such as anionic or cationic polyacrylamide or neutral high molecular weight polyethylene oxide, as described in Payne et al., can then be added to flocculate the pin flocs. The flocculated pin flocs can be referred to as flocs.

Whether to use coagulation and/or flocculation generally depends upon the particular contaminants present in a given waste stream. Coagulation may or may not be followed up by flocculation. For example, a bucket of wash plant wastewater may include clay/slimes that settle out clear within a couple of minutes. Flocculation may be used to remove the clay/slimes without the need to employ coagulation. For another example, if the bucket remained turbid after the larger particles settled, coagulation may be used to address the turbidity, followed up flocculation.

The suspensions of the present invention comprise particulate cationic polymers that may be referred to as flocculants or coagulants. Although flocculation and coagulation may involve different processes, both flocculants and coagulants form flocs with contaminants when used to treat water and can be considered to be undifferentiated in the present context.

Useful cationic polymers available in particulate form generally include homopolymers of a cationic monomer or copolymers of one or more cationic monomers. In some embodiments, the particulate cationic polymers are quaternary ammonium compounds or salts. Suitable cationic polymers include, for example, polyDADMAC, cationic polyacrylamide copolymers and DADMAC-acrylamide copolymers. The particulate cationic polymers useful in the suspensions described herein may be effectively provided in small particulate form, e.g., microbeads, or in larger particulate sizes, such as granules. The particulate cationic polymers generally have an average particle diameter from about 1.0 microns to about 800 microns, in further embodiments from about 5.0 microns to about 700 microns, and in other embodiments from about 10.0 microns to about 500 microns, or from about 50 microns to about 200 microns. For particular applications, average particle diameters greater than about 30 microns or in further embodiments from about 40 microns to about 300 microns can be particularly appropriate. Particulate cationic polymers comprising beads may have an average particle diameter greater than about 30 microns, from about 30 microns to about 300 microns or from about 50 microns to about 200 microns. In some embodiments, the particulate polyDADMAC can be granular, ground flakes, mixtures thereof or the like. Particulate cationic polymers comprising flakes or ground flakes may have an average diameter from about 60 microns to about 150 microns. A person of ordinary skill in the art will recognize that additional ranges of average particle diameter within the explicit ranges above are contemplated and are within the present disclosure. In some embodiments, the particulate cationic polymers useful in the suspensions described herein have sufficient cationic charge density and/or molecular weight so that flocs are readily formed during the treatment process in which the suspensions are used.

PolyDADMAC or polydiallyldimethylammonium chloride ((C₈H₁₆NCl)ₙ) is a cationic homopolymer that can be useful as a flocculant agent. Copolymers of DADMAC and acrylamides as well as other copolymers of DADMAC are similarly available commercially and are similarly suitable flocculant applications as an anionic, cationic or neutral copolymer. PolyDADMAC and copolymers thereof generally can have an average molecular weight of at least about 100000 g/mole, in further embodiments at least about 1,000,000 g/mole and can be desirable at average molecular weights of about 5,000,000 to 30,000,000 g/mole. PolyDADMAC can be effectively provided in small particulate form, e.g., microbeads, or in larger particulate sizes, such as granules. For flocculant use, polyDADMAC particles generally have an average particle diameter from about 0.5 microns to about 150 microns. A person of ordinary skill in the art will recognize that additional ranges of average particle diameter within the explicit ranges above are contemplated and are within the present disclosure. PolyDADMAC generally can be dissolved in water at high concentrations as a viscous liquid without gel formation, but the suspensions described herein of polyDADMAC can be desirable for flocculant applications. In particular, in contrast with some other flocculant polymers polyDADMAC has been found to be more effective as a flocculant when added in particulate form directly into a waste stream without first dissolving in water. While the delivery of liquid polymer solutions is convenient from a handling perspective, the desirability of delivery of particulate polyDADMAC into a wastewater flow is described in European patent 0536194 B1 to Payne et al., entitled "Purification of Aqueous Liquor," incorporated herein by reference. Through the delivery of the suspensions described herein, the convenience of liquid phase delivery can be combined with the advantages of the delivery of undissolved polyDADMAC into the wastewater flow.

The particulate cationic polymer may have any useful molecular weight, or average molecular weight, which may depend on the particular application in which the suspension is being used. Generally, the particulate cationic polymer substantially remains in particulate form in the suspension, with little to no dissolution in the nonaqueous carrier fluid. Useful average molecular weights may depend upon the particular cationic polymer properties such as the solubility, charge density or other properties of the cationic polymer in its particulate form.

In corresponding embodiments, the suspensions comprise solid or granular polymer, such as a powder or microbeads, and nonaqueous liquid or carrier fluid components. In particular, with respect to solid components, the suspensions generally can comprise at least about 10 weight percent (wt%), at least about 20 wt%, at least about 25 wt%, at least about 30 wt%, no more than about 85 wt%, from about 10 wt% to about 80 wt%, from about 15 wt% to about 75 wt%, from about 17.5 wt% to about 75 wt%, or from about 20 wt% to about 70 wt% polymer particulates or particles. While the undissolved suspended polymers comprise polyDADMAC, this can be blended with a flocculant polymer, such as high molecular weight polyacrylamide. Generally, polyDADMAC makes up from about 25 wt% to 100 wt%, and in further embodiments from about 30 wt% to about 85 wt% of the suspended polymer. A person of ordinary skill in the art will recognize that additional minimum weight percentages and additional ranges of weight percentages, within those recited here, are contemplated and are within the present disclosure.

In some embodiments, the particulate cationic polymer comprises a homopolymer of a cationic monomer. The cationic monomer may comprise a quaternary ammonium derivative. For example, the particulate cationic polymer may comprise the homopolymer referred to as polyDADMAC. PolyDADMAC in the form of a solid is often characterized as being low, medium or high average molecular weight. Low average molecular weight polyDADMAC may be less than about 100000 g/mol, medium average molecular weight up may be up to 400,000 g/mol, and high average molecular weight may be greater than 400,000 g/mol with commercially available average molecular weight extending into the millions of g/mol. In general, suitable molecular weights can extend to the commercially available upper values of average molecular weight. PolyDADMAC useful as the cationic polymer particles may have an average molecular weight of at least about 100000 g/mole, in further embodiments at least about 1,000,000 g/mole and can be desirable at average molecular weights of about 5,000,000 to 30,000,000 g/mole. Suitable average molecular weight ranges can be from about 100000 g/mole to about 30,000,000 g/mole. in further embodiments from about 200000 g/mole to about 20,000,000 g/mole and in other embodiments from about 250000 g/mole to about 10,000,000 g/mole. A person of ordinary skill in the art will recognize that additional ranges of average molecular weights within the explicit ranges above are contemplated and are within the present disclosure.

In some embodiments, the particulate cationic polymer comprises a copolymer of a cationic monomer. The cationic monomer used to form useful copolymers may comprise a quaternary ammonium monomer. For example, the cationic monomer may be DADMAC. Useful copolymers of DADMAC include DADMAC copolymerized with acrylamide or methacrylamide derivatives thereof. For example, DADMAC may be copolymerized with acrylamide; N-[3- (dimethylamino)propyl]methacrylamide referred to as DADMAC-DMAPMA copolymer; 2-diallyl(methyl)ammonio)acetate referred DADMAC-DAMA copolymer; or vinyl ether of monoethanolamine referred to as DADMAC-VEMEA copolymer.

The particulate cationic polymer comprising a copolymer of a cationic monomer may have an average molecular weight less than about 100000 g/mol, up to 400000 g/mol, or greater than 400000 g/mol with a molecular weight in the millions. For example, the average molecular weight of a particulate cationic polymer that is a copolymer may be at least about 100000 g/mole, in further embodiments at least about 1,000,000 g/mole and can be desirable at average molecular weights of about 5,000,000 to 30,000,000 g/mole. Suitable average molecular weight ranges can be from about 100000 g/mole to about 30,000,000 g/mole. in further embodiments from about 200000 g/mole to about 20,000,000 g/mole and in other embodiments from about 250000 g/mole to about 10,000,000 g/mole. A person of ordinary skill in the art will recognize that additional ranges of average molecular weights within the explicit ranges above are contemplated and are within the present disclosure.

Particulate cationic homopolymers and copolymers polymers are commercially available, such as FLOQUAT polymers from SNF Floerger®-USA (SNF Group) and HENGFLOC polymers from Beijing-Hengju Chemical Group Corporation.

The liquid or carrier fluid used in the suspensions is generally a nonaqueous liquid, such as a mineral oil. The carrier fluid is generally selected such that little to no particulate cationic polymer dissolves in the carrier fluid. In some embodiments, the particulate cationic polymer can be soluble in the carrier fluid at less than about 1 wt%, less than about 0.5 wt%, less than about 0.2 wt%, from about 0 wt% (measurement limit) to about 1 wt%, or from about 0.01 wt% to about 0.5 wt%. The nonaqueous carrier fluid may include a low amount of water as long as the particulate cationic polymer remains in particulate form to whatever extent is desired and reasonable cost mineral oil generally includes a small amount of contaminant water. A person of ordinary skill in the art will recognize that additional ranges of weight percentages within the explicit ranges above are contemplated and are within the present disclosure. In some embodiments, the nonaqueous carrier fluid or liquid is immiscible with water. In some embodiments, the nonaqueous carrier fluid or liquid is a liquid at room temperature.

The nonaqueous carrier fluid or liquid may be or comprise mineral oil. Mineral oils are generally not a single substance but are composed of a mixture of hydrocarbons isolated from crude petroleum oil. Mineral oils comprise three main types of compounds: saturated paraffins, napthenes and aromatics. Paraffins, such as octane and 2-methyl heptane, are linear and branched hydrocarbons that include only single carbon-carbon bonds. Napthenes, such as cyclohexane and decalin, include cyclic aliphatic hydrocarbons having only single carbon-carbon bonds. Aromatics, such as toluene and 3,4-benzopyrene, include mono- or multicyclic unsaturated hydrocarbons having carbon-carbon double bonds.

Suitable mineral oils include those obtained from a mineral source such as petroleum. Petroleum mineral oil can be manufactured from crude oils by vacuum distillation or the like to produce several distillates and a residual oil. The residual oil can be further refined to reduce levels of aromatics. Any mineral oil can be used to prepare the suspensions described herein as long as the suspension can function as desired. For a general listing of synonyms, tradenames and CAS Registry Numbers, see the compound summary available from the U.S. National Library of Medicine, PubChem Reference Collection SID 482026796, available June 8, 2023, (pubchem.ncbi.nlm.nih.gov), incorporated herein by reference. Other suitable mineral oils are used in agriculture such as for livestock; see compilation by Savan Group entitled “Mineral Oil-Technical Report-2021”, March 26, 2021, available at www.ams.usda.gov, incorporated herein by reference.

While any suitable mineral oil can be used, preferable mineral oils have contaminant levels that meet regulations in a jurisdiction. Suitable mineral oils have appropriately low contaminant levels of benzene, toluene, ethylbenzene and xylenes. In some embodiments, the suspension comprises less than about 5 wt% combined amounts of benzene, toluene, ethylbenzene, xylene or xylene derivatives. In some embodiments, the suspension comprises from about 0 wt% to less than about 5 wt% combined amounts of benzene, toluene, ethylbenzene, xylene or xylene derivatives. A person of ordinary skill in the art will recognize that additional ranges of contaminant levels within the explicit ranges above are contemplated and are within the present disclosure.

Suitable mineral oils can be classified by physical properties such as viscosity (kinematic viscosity). Suitable nonaqueous carrier fluids are liquid at room temperature. The mineral oil may have a viscosity, when measured at 25℃, from about 2 cP to about 1000 cP, from about 2 cP to about 500 cP, from about 5 cP to about 300 cP, from about 7 cP to about 200 cP, or from about 10 cP to about 100 cP. A person of ordinary skill in the art will recognize that additional ranges of viscosities within the explicit ranges above are contemplated and are within the present disclosure. The viscosity may be targeted within a particular range which can depend upon the method or equipment used to deliver the suspension as described below. For example, the carrier fluid may need to have a viscosity within a particular range depending on the type of pump being used in a treatment operation.

Suitable mineral oils can have a density less than that of water, for example, less than 0.98 g/mL, less than 0.95 g/mL, or from about 0.8 g/mL to about 0.95 g/mL, at room temperature.

The mineral oil can be a refined or highly refined product depending on the particular grade selected for use. Suitable mineral oils include those that are transparent liquids which may be colorless or colored. Exemplary mineral oils include white mineral oil (CAS 64742-47-8), light mineral oil or food grade mineral oil (CAS 8042-47-5), food grade white oil (CAS 92062-35-6), or heavy mineral oil (CAS 8012-95-1). Other suitable mineral oils are identified in the references cited above such as the Pubchem Reference Collection SID 482026796 and the Technical Report available at the USDA website.

While the suspensions can consist essentially of particulate cationic polymer and carrier fluid, minor components or additives can be included in the suspension if desired to modify the properties of the suspension, such as suspension aids, coloring agents, viscosity modifiers, surfactants, or the like. The minor components or additives may be liquids or particles that may or may not dissolve in the nonaqueous carrier fluid. Clay particles are an example of a suspension aid that may be included in the suspensions. The minor components, if used, are generally in amounts of no more than about 5 wt% each and no more than about 15 wt% total. The minor components do not change the fundamental nature of the suspension with respect to maintaining flowability and insolubility of the polymer particles.

To achieve the desired purpose of the suspension embodiments, the suspensions do not need to be stable and as a general matter may not be, although it is not problematic if the suspensions are coincidently stable. Stability in this context is intended to mean that a well mixed suspension remains homogenous. In general, the suspensions separate with the solids concentrating toward the bottom of a container due to gravity. However, the suspensions can be mixed to form a homogenous suspension when desired, such as for delivery for a particular application, as described further below.

The suspensions may be used with or without modification. Generally, the suspensions can be modified as long as the suspension can be used as desired. In some embodiments, the suspensions may be modified by adding additional components. In other embodiments, the suspensions may be diluted with a liquid such as a nonaqueous liquid, which may or may not be the same or similar carrier fluid. If the suspensions are to be pumped and/or metered into water to be treated, properties such as viscosity may need to be within a particular range depending on the equipment being used. In some embodiments, the suspensions can be delivered from a suitable mixer to provide for delivery of a uniform composition, generally in selected metered amounts, and delivered into a container for dilution with water shortly prior to delivery into the waste stream.

In some convenient commercial applications, the suspension product can be efficiently pumped from totes or bulk storage to elevated application points, where it is directly applied to the wastewater stream. This method allows the dry polyDADMAC particles to disperse within the stream and begin dissolving, thereby maintaining the performance advantages of the dry form over the solution form. Additionally, the suspension product simplifies operations by eliminating the need for dry feeder systems and reducing the frequency of bag changes or powder loading.

The suspensions are useful for removal of contaminates present in water. The suspensions may be used to treat wastewater, such as waste streams generated with mining operations. Mines generally produce flow of relatively dilute waste streams with tailings, also referred to as mineral slimes. The waste streams produced by mining operations often include clay, claylike waste or other silicate or metal oxide particulate waste. Mining operations include phosphate mining, bauxite mining, coal washing, dredging, talc mining, other sand mining, alumina processing and the like. The suspensions can be injected into a waste stream containing suspended contaminants that is then directed to a settling tank, or the like. The flocs formed by the particulate cationic polymer and contaminants are then processed as described further below.

In some embodiments, the suspensions can be added in part early in the waste flow with optional additional portions added along the flow to drive relatively slow formation of flocs. In some embodiments, the suspensions can be added essentially at or near the point of entry of the waste flow into a settling tank due to the relatively fast formation of flocs. Proper incorporation or mixing of the suspension into the waste stream facilitates this earlier delivery without interfering with the desirable flow of the waste stream through conduits leading to a settling tank. If the suspensions are delivered in a water dilution flow, the degree of dissolving of the particulate cationic polymer can be controlled to yield a desired state of the polymer when delivered into the waste stream, fiber de-watering site or other site for use. An earlier delivery of the suspensions can result in improved mixing within the waste flow, which can result in the reduced use of suspension while improving the effectiveness of the particulate cationic polymer. In particular, in some embodiments, a suspension can be added at least 10 meters upstream from a port, e.g., central inlet, into a settling tank. When delivered in a water dilution flow, any reasonable water source can be used to generate the flow.

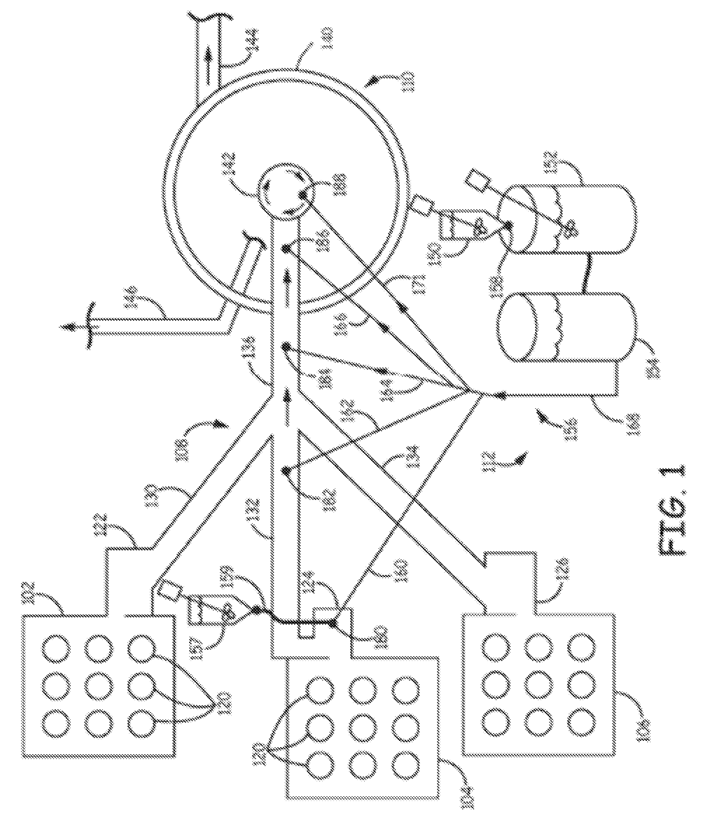

A representative configuration of a waste treatment facility for the treatment of wastewater with mining tailings is shown in FIG. 1. The waste treatment facility for a mining operation comprises mineral processing stations 102, 104, 106, slime flow conduit system 108, thickening tank 110 and suspension delivery system 112, which in particular is suitable for delivery of the suspensions described herein. The configuration of the mineral processing stations can depend on the particular mining operation, and these stations can comprise hydrocyclones 120 or the like or other suitable purification equipment to separate crudely purified mineral ore from slimes, i.e., dilute tailing waste from the mineral separation. In some embodiments, a mineral processing station can comprise a head box 122, 124, 126 to direct slime/waste flow from a mineral processing station to the waste flow conduit system. While FIG. 1 shows three mineral processing stations 102, 104, 106, in other embodiments a waste facility may interface with a single mineral processing station, two, four, five or more than five mineral processing stations.

Slime flow conduit system 108 provides for flow of the waste stream from mineral processing stations 102, 104, 106 to thickening tank 110, and generally slime flow conduit system 108 interfaces with suspension delivery system 112 at one or more points. With the configuration shown in FIG. 1, slime flow conduit system 108 comprises flow lines 130, 132, 134 that lead to combined flow line 136. Flow lines 130, 132, 134, respectively connect to head boxes 122, 124, 126 to receive slimes from mineral processing stations 102, 104, 106, respectively. The size and construction of flow lines 130, 132, 134, 136 can be designed based on the particular mining operation and corresponding waste volumes, and flow limes 130, 132, 134, 136 can be pipes, open or closed ducts or any other suitable flow structure. For a representative phosphate mining operation flow lines 130, 132, 134 can be pipes with a diameter of roughly 10-40 inches, and combined flow line 136 can be a pipe with a diameter of roughly 30-60 inches, but the basic teachings herein can apply to a range of processing operations and mining volumes. As noted above, a particular system can comprise a different number of mineral processing stations and corresponding modifications to slime flow conduit system 108 follow from the teachings herein.

Thickening tank 110 can comprise a tank structure 140, a central inlet 142, a clarified water outflow 144 and tailings outflow 146. Tank structure 140 can have a suitable volume for the particular mining operation size. Central inlet 142 provides an interface with combined flow conduit 136 such that slime can enter the tank structure 140. Central inlet 142 can be simply an end opening of combined flow conduit 136, but in some embodiments, central inlet 142 can comprise a circular ring like structure with optional mechanical mixing to provide for a mixed slime flow into tank structure 140 to facilitate flocculation. In the thickening process that takes place in tank structure 140, flocs can have a higher density and fall to the bottom of the tank, and less dense clarified water can be found near the top of the tank. Clarified water outflow 144 can be configured to take off water from near the top of the tank, such as the top 20%-40% of the tank volume and in further embodiments the top 10% of the tank volume, and in general near the edge of the tank. Similarly, tailings outflow 146 can be configured to withdraw concentrated tailings from the flocculation process near the bottom of the tank and in some embodiments toward the center of the tank, in some embodiments from the bottom 20% of the tank volume and in further embodiments from the bottom 10% of the tank volume. A person of ordinary skill in the art will recognize that additional ranges of positions for water removal within the explicit ranges above are contemplated and are within the present disclosure.

Referring to FIG. 1, suspension delivery system 112 comprises a suspension reservoir 150 that can comprise a mixer to maintain a relatively homogenous form of the suspension, a mixing/dilution tank 152, a storage tank 154 and feed lines 156. Suspension reservoir 150 generally holds a desired quantity of the suspension and can comprise a feed valve 158 or the like to provide for the placement of a selected amount of suspension into mixing/dilution tank. Suspension reservoir 150 generally can provide continuous mixing of the suspension so that a homogenous suspension can be metered out of the reservoir. Mixing/dilution tank 152 generally has an appropriate mixing element and can be configured generally to operate in a batch or continuous mode of operation. Water is generally correspondingly delivered into mixing/dilution tank 152 to provide a desired concentration of suspension, as described above. The suspension can be pumped or otherwise flowed for storage to storage tank 154 for delivery as needed to the waste stream through feed lines 156. In alternative embodiments, suspension reservoir 150 can be configured for direct delivery of the suspension into feed lines 156 or a portion thereof. If desired, mixing reservoir 157 can be configured for direct delivery of the suspension through line 159 to head box 124.

As noted above, it can be desirable to directly deliver the suspensions with dilution water flow so that dissolving of the particulate cationic polymer is controlled. Referring to FIG. 2, direct suspension delivery system 161 comprises suspension reservoir 163 that can comprise a mixer to maintain a relatively homogenous form of the suspension, water supply line 165, and feed line 167. Suspension reservoir 163 generally holds a desired quantity of the suspension and can comprise a feed valve 169 or the like to provide for the placement of a selected amount into the water supply line 165 at a predetermined rate. Suspension reservoir 163 generally can provide continuous mixing of the suspension so that a homogenous suspension can be metered out of the reservoir. Water supply line 165 generally has a controlled flow rate selected to allow for proper dissolution of the particulate cationic polymer prior to entering the waste stream as described above. The length of time the particulate cationic polymer is in the water flow can be determined by the length of the pipe, the diameter of the pipe, the flow rate or a combination thereof. The arrows indicate the direction of the flow. In some embodiments, the diameter of water supply pipe 165 can be about 0.1 inch to about 1 inch, although particular applications generally suggest desired flow volumes. Feed line 167 can connect, for example, with the feed line 156 or with feed line 159 or other alternative configurations to have desired flow lengths and flow volumes based on selected delivery points for the delivery of the suspension.

Feed lines 156 provide for flow from storage tank 154 to slime flow conduit system 108, and pumps can be used as appropriate to drive the flow. As shown in FIG. 1, feed lines 156 comprise five branch feeds 160, 162, 164, 166, 171 from main feed line 168, which connects with storage tank 154. The feed lines can be appropriate pipes or other conduits. Branch feeds 160, 162, 164, 166, 171 connect between main feed line 168 and delivery connections 180, 182, 184, 186, 188 that connect with corresponding points of the slime flow conduit system. As shown in FIG. 1, delivery connection 180 is located at head box 124, delivery connection 182 is on flow conduit 132, delivery connections 184, 186 are located at different points on combined flow conduit 136, and delivery connection 188 is located at central inlet 142. In additional or alternative embodiments, a different number of branch flow conduits can be used, such as 1, 2, 3, 4, 6 or more than 6, and the positions of the delivery connections can be altered as desired. Similarly, a system can comprise more than one suspension delivery system if desired to supply suspension to various delivery connections.

The suspension can be added at the central inlet into the thickening tank, e.g., delivery connection 188 in FIG. 1. The delivery of a suspension at or near the central inlet limits the mixing with the waste stream prior to entry into the thickening tank. Overall the suspension provides outstanding formation of flocs and improved delivery flexibility. The suspension can be delivered effectively through a delivery port into the slime flow at least 10 meters from the port connecting the waste flow with the thickening tank settling zone, in further embodiments at least about 12 meters and in additional embodiments from 15 meters to the initiation of the waste flow adjacent to the mineral processing station. A person of ordinary skill in the art will recognize that additional ranges of distances within the explicit ranges above are contemplated and are within the present disclosure.

For the delivery of the suspensions, suspension delivery system 112 or portions thereof can be replaced with appropriate components for the delivery of the suspension. For example, a reservoir of suspension can be directly connected at delivery connections 180, 182, 184, 186, 188. The suspension can then be directly delivered at selected rates into the flow. As noted above, in some embodiments, a dilution water flow can be used to deliver the suspension with some dissolving of the particulate cationic polymer. A diluted suspension can be directed individually to one or more delivery connections and/or to branched feeds directed to two or more delivery connections.

While the suspensions can be effectively used in various waste processing situations and/or fiber dewatering processes, it is instructive to review a representative procedure. For example, a slime flow coming from the mineral processing stations can have a solids concentration from about 1 wt% to about 12 wt%. The objective can be to concentrate to solids in the waste to levels generally from about 15 wt% to about 45 wt% and in further embodiments from about 20 wt% to about 35 wt% in the under flow removed from the thickening tank. The clarified water removed from the thickening tank can have at least about 90 percent, in some embodiments at least about 95 percent, and in further embodiments at least about 99 percent of the initial solids removed. In general, the volume of suspension is added in a dosage from about 1 parts per million by weight (ppm) to about 50 ppm, in some embodiments from about 5 ppm to about 40 ppm, and in further embodiments from about 10 ppm to about 30 ppm of particulate cationic polymer within the treated slime flow, i.e., 1 part particulate cationic polymer per 1 million parts of waste water by weight assuming that the waste water is 1 kilogram per liter. A person of ordinary skill in the art will recognize that additional ranges of processing parameters within the explicit ranges above are contemplated and are within the present disclosure. The suspensions can provide for a reduced use of particulate cationic polymer in order to achieve a desired high purity of water effluent.

In addition to cleaning mining wastewater, the suspensions can be effectively used in other wastewater treatment contexts, such as to removal of fibrous particulates from waste streams. Thus, the suspensions can be effectively used for wastewater treatment from paper mills and the like. Paper mill dewatering processes can be performed to form fiber cakes that can be recycled into useful materials. Thickening of fiber sludge can be performed by filtration or sedimentation, such as with clarifiers or floatation units. To facilitate cake formation, the dewatering process can involve screw presses, belt presses, centrifuges or other dewatering of waste fibers. A fiber cake can have a solid content of at least about 20 wt%, and in some embodiments at least about 25 wt%. The initial sludge can have a solid content generally from roughly 1 wt% to about 15 wt%. The use of flocculant polymers generally for the treatment of waste streams from paper mills, pulp mills or deinking plants is described generally in U.S. patent 6,123,856 to Kumpera et al., entitled "Dewatering of Sludges," incorporated herein by reference.

Furthermore, the suspensions can be useful as fiber retention agents in paper making processes and the like for fiber materials. Paper is formed on a screen or the like where the fibrous material is dewatered to form the paper. The retention of fibers in the paper both increases yield of the paper product and reduces fiber particulates in the mill waste stream, which can increase the clean up burden. Thus, small quantities of the particulate cationic polymers can be combined with the paper forming material to reduce fiber loss from the material during dewatering. The use of cationic or anionic polyacrylamide polymers to aid in paper dewatering is described in U.S. patent 4,795,531 to Sofia et al., entitled "Method for Dewatering Paper," incorporated herein by reference.

A useful suspension for the treatment of waste streams from mining operations includes from about 50 wt% to about 70 wt% dry polyDADMAC powder or micro-beads and less than about 5 wt% clay suspension aid in mineral oil. The micro-bead version offers superior flowability and lower suspension viscosity due to its shape and physical properties. A 275-gallon tote of this suspension can economically replace twenty 275-gallon totes of 20 wt% aqueous solutions of polyDADMAC which may be due to a higher activity concentration (50 wt% versus 20 wt%) and the 8 to 1 performance ratio of the undissolved polymer versus the dissolved polymer.

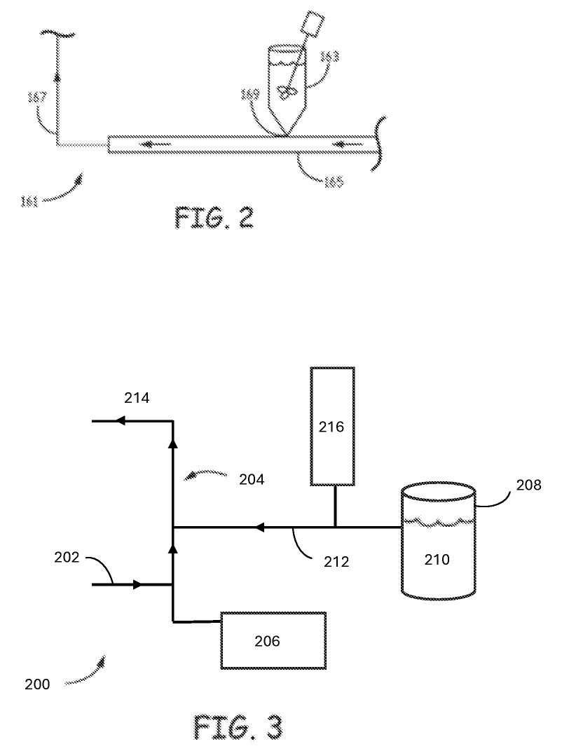

An exemplary system for treatment of a waste stream generated from a mining operation is shown in FIG. 3. System 200 is set up near a mining operation which generates a waste stream that is fed as wastewater to system 200 via wastewater inlet pipe 202. General direction of flow within the system is indicated by arrows. The wastewater from the waste stream enters main pipe 204 and is pumped in a forward direction away from pump 206. Reservoir 208 holds suspension 210 and is configured to deliver the suspension to main pipe 204 via reservoir inlet pipe 212. Suspension 210 combines with wastewater at an entry location along the main pipe and the resulting treated wastewater exits the system via outlet pipe 214. System 200 can include equipment such as controllers for controlling pump speed or optional cartridges 216 for monitoring pressure.

Pump 206 is a progressing cavity pump such as a CP Model pump available Continental Pump Co. or a Moyno™ pump available from Moyno, Inc. Useful pumps include those that push the treated water forward such as those including a worm gear with poly stator. Pump 206 may be any type of pump as long as system 200 functions as desired. Gear, piston or diaphragm pumps may clog due to one way check valves and low tolerance flow zones that will allow the carrier fluid to pass but essentially filter out the particulate polymer. Suspension 210 comprises from about 40 to about 60 wt% polyDADMAC beads having an average particle size from about 20 mm to about 100 mm (mesh number 20-100). The polyDADMAC beads were HENGFLOC109 available from Beijing Hengju Chemical Group Corp. The beads were suspended in mineral oil such that the suspension had a viscosity of about 5 cP.

The system similar to that shown in FIG. 3 was set up to receive water overflow from a thickener at a sand plant located in Wisconsin. A nonaqueous suspension comprising 50 wt% polyDADMAC beads (HENGFLOC109) in mineral oil was used to treat the overflow. Large black flocs were observed upon addition of the suspension. An aqueous solution of 20 wt% polyDADMAC in water was used to treat the overflow in order to compare performance with that of the nonaqueous suspension. It was found that 15 mL of the nonqueous suspension could be used to replace 150 mL of the aqueous solution such that a 10 to 1 replacement or performance ratio was observed.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term "about" herein refers to measurement error for the particular parameter unless explicitly indicated otherwise.

What is claimed is:

1. A suspension comprising mineral oil and at least about 10 wt% of particulate polydiallyldimethylammonium chloride (polyDADMAC).

2. The suspension of claim 1, wherein the particulate polyDADMAC has an average molecular weight from about 100,000 g/mol to about 1,000,000 g/mol.

3. The suspension of claim 1, wherein the particulate polyDADMAC has an average molecular weight of at least 1,000,000 g/mol.

4. The suspension of claim 1, wherein the particulate polyDADMAC comprises a powder having an average particle diameter from about 0.5 microns to about 150 microns.

5. The suspension of claim 1, wherein the particulate polyDADMAC comprises beads having an average particle diameter from about 50 microns to about 200 microns.

6. The suspension of claim 1, wherein the particulate polyDADMAC comprises beads having an average particle diameter from about 20 mm to about 100 mm.

7. The suspension of claim 1, wherein the mineral oil has a viscosity of less than about 200 cP at 25℃.

8. The suspension of claim 1, wherein the suspension has a viscosity of less than about 200 cP at 25℃.

9. The suspension of claim 1, wherein the mineral oil has a density from about 0.8 g/mL to about 0.95 g/mL.

10. The suspension of claim 1, wherein the suspension comprises less than about 5 wt% combined amounts of benzene, toluene, ethylbenzene, xylene or xylene derivatives.

11. The suspension of claim 1, wherein the particulate polyDADMAC is at a concentration of at least about 30 wt%.

12. The suspension of claim 1, wherein the particulate polyDADMAC is at a concentration from about 40 wt% to about 80 wt%.

13. A method for removing contaminants from a waste stream, the method comprising:
delivering a suspension of a particulate polyDADMAC in mineral oil to a waste stream at a delivery point; and
collecting flocs downstream from the delivery point to remove polyDADMAC and accumulated contaminants associated with the flocs.

14. The method of claim 13, wherein delivering the suspension comprises pumping the suspension from a storage tank.

15. The method of claim 13, wherein the waste stream originates from coal mining or mineral mining.

16. The method of claim 13, wherein the collecting flocs downstream from the delivery point provides or facilitates water clarification, suspended solids separation, treatment flow thickening, dissolved air floatation, selective mineral separation, dredging, belt press or centrifuge dewatering, or settling pond or reservoir impoundment.

17. The method of claim 13, wherein the collecting flocs downstream from the delivery point results in a treated waste stream, and the method further comprises delivering the treated waste stream to a settling tank.

18. A system for treatment of a waste stream, the system comprising:
a reservoir holding a suspension of particulate cationic polymer in mineral oil; and
a conduit connected to the reservoir and configured to deliver the suspension from the reservoir into a waste stream.

19. The system of claim 18, wherein the system comprises from two to six conduits, each conduit configured to deliver the suspension from the reservoir into the waste stream at different delivery points along the waste stream.

20. The system of claim 18, wherein the waste stream originates from coal mining or mineral mining.
